(19) United States
(12) Patent Application Publication
(10) Pub. No.: US 2019/0028051 A1
(43) Pub. Date: Jan. 24, 2019

(54) Vacuum Pump Drive Having Two Frequency Converters

(71) Applicant: Leybold GmbH, Koeln (DE)

(72) Inventor: Sebastian Walzel, Unna (DE)

(21) Appl. No.: 16/069,711

(22) PCT Filed: Dec. 23, 2016
(86) PCT No.: PCT/EP2016/082569

§ 371 Date: Jul. 12, 2018

(30) Foreign Application Priority Data
Jan. 13, 2016 (DE) 202016000217

(51) Int. Cl. H02P 23/26; H02P 27/04; F04D 25/06; F04D 27/00

(52) U.S. Cl. CPC H02P 23/26; F04D 27/001; F04D 25/06; H02P 27/047

(57) ABSTRACT

The invention relates to a vacuum pump drive including an electric motor driving the rotor of a vacuum pump, a first frequency converter connected to the electric motor and designed to generate a motor input voltage for driving the electric motor from a network supply voltage, at least one second frequency converter that is also designed to generate a motor input voltage of a variable frequency from a network supply voltage, in order to drive the motor according to the frequency of the motor input voltage, characterized in that the second frequency converter is provided with a measuring device, which is provided for measuring the motor input voltage generated by the first frequency converter and/or the related motor input current, in order to synchronize the second frequency converter with the first frequency converter.

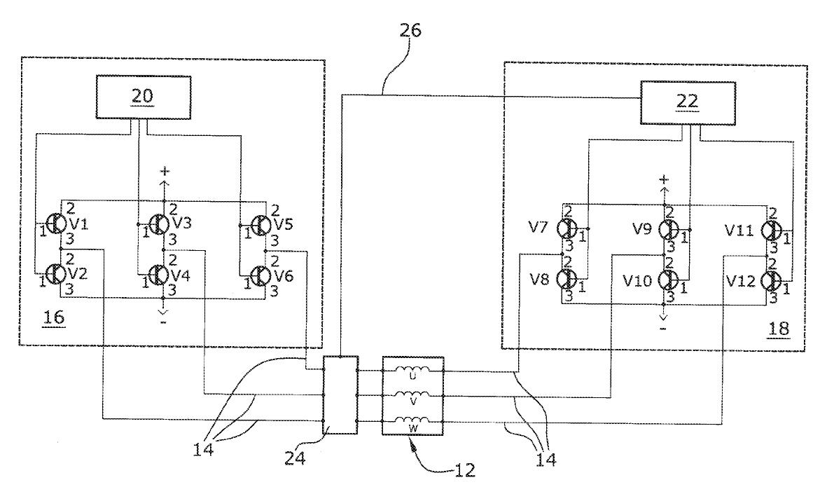

The invention relates to an electric drive for a vacuum pump.

Electric drives for vacuum pumps typically comprise an electric motor which generates the torque necessary for driving the rotor of the vacuum pump in dependence on the motor input voltage supplying the motor. The motor input voltage with a variable frequency and voltage is generated by a frequency converter which is supplied with mains supply voltage from a voltage supply network.

With respect to an electric drive of vacuum pumps, the power dissipation generated in an electric motor is an important design criterion. The level of the power dissipation determines the possible performance of the vacuum pump. For a given structural volume of the pump drive, a power dissipation as low as possible is intended to be achieved, with the mechanical performance of the motor being as high as possible.

For this purpose, it is known to operate the electric motor of a pump drive with two frequency converters, wherein the frequency converters are synchronized with each other. One frequency converter is connected to one end of the motor windings, and the other frequency converter is connected to the opposite end of the motor windings.

For a synchronization of the two frequency converters, these comprise interconnected control units for the exchange of data required for the synchronization of the frequency converters. Such a synchronous drive with two frequency converters is described for example in “DTC of Open-End Winding Induction Motor Drive Using Space Vector Modulation With Reduced Switching Frequency”, A. Kumar, B.G. Fernandes, K. Chatterjee, 2004 35th Annual IEEE Power Electronics Specialists Conference, Aachen, Germany, 2004.

As an alternative it is known to synchronize the two frequency converters by operating them with only one common control unit controlling both frequency converters.

It is an object of the invention to provide an electromotive vacuum pump drive with two frequency converters which can be synchronized in a simple manner in order to reduce the power dissipation of the electric motor.

The vacuum pump drive of the present invention is defined by the features of claim 1.

According to this, the second frequency converter is provided with a measuring device configured to detect the motor input voltage of the electric motor generated by the first frequency converter and/or the motor current for the electric motor generated by the first frequency converter. The second frequency converter is configured to generate the motor input voltage in dependence on the signal measured by the measuring device, so as to be driven synchronously with the first frequency converter. Thus, the invention allows a simplified synchronization of the motor input voltages generated by the two frequency converters without requiring a direct data link between the two frequency converters or between their respective control units for the synchronization of the frequency converters. Preferably, such a data link does not exist between the frequency converters for the synchronization of the same. In particular, no common control unit is provided that controls both frequency converters. Rather, each frequency converter has an own control unit between which no data are exchanged for the synchronization of the frequency converters.

The first frequency converter generates a variable motor input voltage with an adjustable frequency. The electric motor generates a drive torque for driving the vacuum pump rotor in dependence on the motor input voltage. Here, the first frequency converter receives no information about the output voltage of the second frequency converter—neither via a connecting line between the frequency converters, nor via a measuring device.

The measuring device is configured to detect the motor input voltage generated by the first frequency converter and/or the motor input current generated by the first frequency converter. Here, the measuring device is connected with the second frequency converter, preferably a control unit of the second frequency converter, in an electrical or electronic or optical manner, so as to transmit a measuring signal to the second frequency converter, from which signal the frequency and the level of the motor input voltage or of the motor input current of the first frequency converter can be determined. The second frequency converter, preferably its control unit, is configured to generate a motor input voltage in dependence on the determined output voltage generated by the first frequency converter, the frequency and level of this motor input voltage being adjusted (synchronized) to the measured motor current.

The motor input voltage generated by the first frequency converter is applied at one end of the electric windings of the electric motor, while the motor input voltage of the second frequency converter is applied at the opposite ends of the motor windings.

In particular, the two frequency converters of the present invention together with the measuring device of the present invention may also be configured to drive a plurality of electric motors and may be connected with the same. Further, it is conceivable that at least one further frequency converter is provided in addition to the second frequency converter, which further frequency converter is also synchronized with the first frequency converter via the measuring device of the second frequency converter. As an alternative, each further frequency converter may comprise an own measuring device to allow a synchronous operation with the first frequency converter or another previous frequency converter. Here, it is possible to e.g. synchronize a third frequency converter with the second frequency converter via an own measuring device.

The following is a detailed explanation of an embodiment of the invention with reference to the FIGURE. The FIGURE schematically shows a schematic circuit of the embodiment.

The electric motor of the vacuum pump drive is schematically illustrated as a block with the reference numeral 12. For the purpose of illustration, the motor windings of the three phases U, V, W are illustrated in the block representing the electric motor 12.

The one end, i.e. the left end in the FIGURE, of the motor windings is connected to a first frequency converter 16 via an electric three-phase connecting line 14. The opposite end, i.e. the right end in the FIGURE, of the motor windings is connected to a second frequency converter 18 via a separate electric three-phase connecting line. Each of the two frequency converters 16, 18 comprises an own control unit 20, 22. No data link exists, be it between the two frequency converters 16, 18 or between the two control units 20, 22.

Both frequency converters 16, 18 each comprise six transistors of which two are assigned to one of the three motor phases U, V, W, respectively. In other words: two first transistors are electrically connected to the first motor phase U, two second transistors are electrically connected to the second motor phase V and two third transistors are electrically connected to the third motor phase W, respectively. All transistors are electrically connected to the supply voltage of a mains voltage network not illustrated in the FIGURE. In addition, all transistors of the first frequency converter 16 are connected to the control unit 20 and all transistors of the second frequency converter 18 are connected to the second control unit 22.

A measuring device 24 is arranged in the connecting line 14 between the first frequency converter 16 and the electric motor 12, which measuring device measures the motor input voltage generated by the first frequency converter 16 in the connecting line 14 and/or the motor input current and/or the motor input voltage generated by the first frequency converter 16 in the electric connecting line 14.

The measuring device 24 is connected to the control unit 22 via a measuring line 26, so as to transmit the measuring signal, which includes information about the frequency and the level of the motor input voltage and/or of the motor current in the line 14, to the control unit 22 of the second frequency converter 18.

The frequency converter 18 with the control unit 22 is configured to generate a motor input voltage in the connecting line 14 in dependence on the measuring signal of the measuring device 24. Thereby, the motor input voltage of the second frequency converter 18 present in the connecting line 14 between the second frequency converter 18 and the electric motor 12 is synchronized with the motor input voltage of the first frequency converter 16 present in the connecting line 14 between the first frequency converter 16 and the electric motor 12.

There is no direct connection between the two frequency converters 16, 18 and in particular not between their control units 20, 22. Each of the two frequency converters 16, 18 generates an own motor input voltage present at a respective end of the motor windings of the electric motor 12. Here, the first frequency converter 16 has no information about the output voltage of the second frequency converter 18. Via the measuring device 24, the second frequency converter 18, however, has information about the motor input voltage generated by the first frequency converter 16.

With the two frequency converters 16, 18 being connected to and controlled by an electric motor 12 (or also a plurality of electric motors 12) in the manner according to the invention for driving vacuum pumps, the power dissipation occurring in the electric motor can be reduced. The electric motor 12 is connected such that at a given supply voltage of the respective frequency converter 16, 18, a higher motor input voltage is generated than with a conventional connection.

The frequency converter 16 is a conventional frequency converter or inverter for controlling an electric motor and includes the control or feedback control structure for controlling or feedback controlling the electric motor.

The distinctive feature of the invention is that no data link exists between the two control units 20, 22 for a synchronization of the frequency converters 16, 18. There may merely be a connection for other purposes, for example for status detection and error processing. The synchronization of the second frequency converter 18 with the rotating field of the first frequency converter 16 is made possible by means of the measuring device 24 connected to the electric motor. Here, the measuring device 24 is not formed by a mechanical speed or position encoder, but exclusively by a measuring system for the electrical actual values of the voltage and/or of the current in the connecting line 14 at the electric motor 12.

Due to the connection of the two frequency converters 16, 18 as provided by the invention, their output voltage can be increased up to 57 percent at the same mains supply voltage, using standard components (frequency converter, measuring device 24). This allows a design of the electric motor 12 for a higher motor voltage or a reduction of the power dissipation in the electric motor 12 at the same driving power.

1. A vacuum pump drive comprising
an electric motor driving the rotor of a vacuum pump,
a first frequency converter connected to the electric motor and configured to generate a motor input voltage for driving the electric motor from a mains supply voltage,
at least one second frequency converter that is also configured to generate a motor input voltage of a variable frequency from a mains supply voltage, in order to drive the motor according to the frequency of the motor input voltage,
wherein the second frequency converter is provided with a measuring device, which is provided for measuring the motor input voltage generated by the first frequency converter and/or the related motor input current, in order to synchronize the second frequency converter with the first frequency converter.

2. The vacuum pump drive of claim 1, wherein no data link for the synchronization of the frequency converters exists between the two frequency converters.

3. The vacuum pump drive of claim 1, wherein the measuring device measures the current and/or the voltage in the connecting line between the first frequency converter and the electric motor.

4. The vacuum pump drive of claim 1, wherein each frequency converter comprises a separate control unit for controlling the respective frequency converter, there existing no communication link between the frequency converters for their synchronization.

5. The vacuum pump drive of claim 1, wherein the second frequency converter is configured to generate the motor input voltage based on the measured values of the measuring unit.
